(19) United States
(12) Patent Application Publication
(10) Pub. No.: US 2020/0032742 A1
(43) Pub. Date: Jan. 30, 2020

(54) ROTARY THROTTLE VALVE AND CARBURETOR

(71) Applicant: Walbro LLC, Tucson, AZ (US)

(72) Inventor: Teruhiko Tobinai, Sendai-City (JP)

(21) Appl. No.: 15/735,796

(22) PCT Filed: Jun. 24, 2016
(86) PCT No.: PCT/US2016/039324

§ 371 Date: Dec. 12, 2017

Related U.S. Application Data
(60) Provisional application No. 62/184,563, filed on Jun. 25, 2015.

(51) Int. Cl. F02M 9/08; F02M 19/04

(52) U.S. Cl. CPC F02M 9/08; F02M 19/04

(57) ABSTRACT

A rotary throttle valve for a carburetor may include a body and a throttle lever integrally formed with the body in one piece. The body may be generally cylindrical and adapted to be received in a cylindrical valve bore of a carburetor for rotation within and relative to the valve bore, and the body includes a valve passage through which air flows. The throttle lever is integrally formed with the body and adapted to be coupled to a driver that rotates the throttle valve. Among other things, by being integrally formed from the same piece of material as the valve body, the throttle lever can be accurately aligned with the valve body, and hence, the valve bore in which the body is received in use.

### REFERENCE TO CO-PENDING APPLICATIONS

This application claims the benefit of U.S. Provisional Patent Application Ser. No. 62/184,563 filed Jun. 25, 2015, which is incorporated herein by reference in its entirety.

### TECHNICAL FIELD

The present disclosure relates generally to carburetors.

### BACKGROUND

A conventional rotary throttle valve carburetor for use in small internal combustion engines such as lawn mowers, motor scooters and the like comprises a cylindrical rotary throttle valve with a valve passage that is selectively and variably registered with a mixing passage of the carburetor by rotating the throttle valve about an axis generally perpendicular to the mixing passage. A needle valve extends into the passage of the rotary valve, and a fuel nozzle projects into the mixing passage and slidably receives the tip of the needle valve. The needle is carried by a first portion of the throttle valve body which is coupled to a second portion of the throttle valve body in which the valve passage is formed. A throttle valve lever is a separate component that is attached to the end of the throttle valve shaft, and a separate swivel is connected to the throttle valve lever.

In such a rotary throttle valve carburetor, a valve bore rotatably receives the throttle valve and is closed by a lid, and the lid defines a bearing portion for journaling a shaft projecting from the throttle valve. The throttle valve is journalled both by the valve bore provided in the carburetor main body and the bearing portion provided in the lid. Because the carburetor main body and lid are manufactured and finished separately, it is necessary to join them together so that an opening in the lid that receives the throttle valve shaft is accurately coaxially aligned with the valve bore, and this requires a relatively high level of manufacturing technology and effort. Further, the multiple pieces of the throttle valve itself need to be coaxially aligned and firmly connected together over the life of the carburetor for proper operation.

To actuate the throttle valve, a lever is connected to the throttle valve and to a cable. The cable usually has an inner cable slidably received in an outer sheath, with the inner cable attached to the throttle valve lever by a swivel carried by the lever. The outer sheath is connected by a lock nut to a cable retaining portion of the lid carried by the carburetor body. So the position of the lid relative to the carburetor body controls the position of the inner cable relative to the throttle valve by way of the connection of the outer sheath to the lid. When the throttle valve is rotated, the end of the inner cable at the swivel moves along an arcuate path, the location of which is also controlled by the position of the lid relative to the throttle valve including the throttle valve lever. Some tolerance is required in the position of the lid on the carburetor body to facilitate manufacture and assembly of the carburetor, and this affects their relative position from one carburetor to another.

### SUMMARY

A rotary throttle valve for a carburetor may include a body and a throttle lever integrally formed with the body in one piece. The body may be generally cylindrical and adapted to be received in a cylindrical valve bore of a carburetor for rotation within and relative to the valve bore, and the body includes a valve passage through which air flows. The throttle lever is integrally formed with the body and adapted to be coupled to a driver that rotates the throttle valve. By being integrally formed from the same piece of material as the valve body, the throttle lever can be accurately aligned with the valve body, and hence, the valve bore in which the body is received in use. The valve body may carry a needle valve and an integrally formed cam surface that is axially inclined relative to an axis of the valve passage to move the needle axially relative to a fuel passage, jet or nozzle.

In at least some implementations, a carburetor includes a main body, and a rotary throttle valve. The main body has a mixing passage and a valve bore intersecting the mixing passage. The rotary throttle valve has a valve body and a throttle lever. The valve body is adapted to be received in the valve bore of the main body for rotation within and relative to the valve bore, and the valve body includes a valve passage aligned with the mixing passage and variably registered with the mixing passage as the throttle valve rotates in the valve bore. The throttle lever is integrally formed with the valve body, extends radially outwardly from the valve body and is adapted to be coupled to a driver that rotates the throttle valve.

### BRIEF DESCRIPTION OF THE DRAWINGS

The following detailed description of certain embodiments and best mode will be set forth with reference to the accompanying drawings, in which:

FIG. 1 is a perspective view of a carburetor including a rotary throttle valve;

FIG. 2 is a partially exploded perspective view of the carburetor showing a cover removed;

FIG. 3 is a cross-sectional view of the carburetor;

FIG. 4 is a top perspective view of a main body of the carburetor;

FIG. 5 is an exploded view of a throttle valve, return spring and fuel flow control valve arrangement of the carburetor;

FIG. 6 is a side view of the carburetor;

FIG. 7 is a side view of a throttle valve of the carburetor;

FIG. 8 is a perspective view of a prior art carburetor;

FIG. 9 is a cross-sectional view of the prior art carburetor;

FIG. 10 is a side view of the prior art carburetor;

FIG. 11 is an exploded view of the throttle valve components, springs and fuel flow control valves of the prior art carburetor;

FIG. 12 is fragmentary perspective view of a carburetor with a cover removed and having a swivel coupled to a throttle valve lever integrally formed with the remainder of the throttle valve;

FIG. 13 is a fragmentary perspective view of the carburetor of FIG. 12 showing the swivel and throttle valve lever;

FIG. 14 is a fragmentary sectional view of the swivel, throttle valve lever (without the attached throttle valve body) and a cover;

FIG. 15 is a perspective view of the swivel; and

FIG. 16 is a perspective view of the throttle valve lever showing only a portion of the throttle valve body extending therefrom.

### DETAILED DESCRIPTION

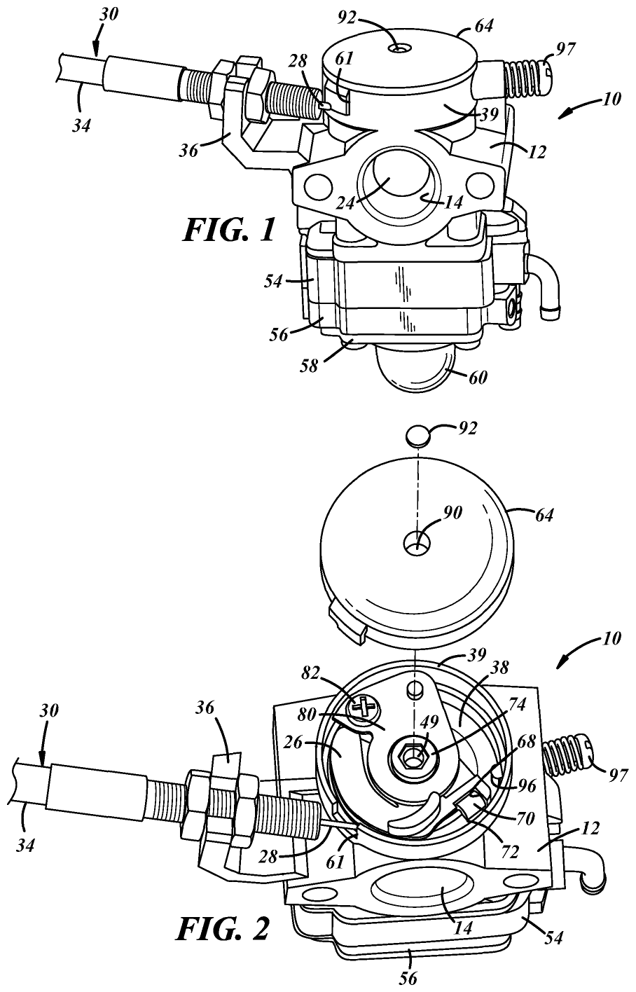

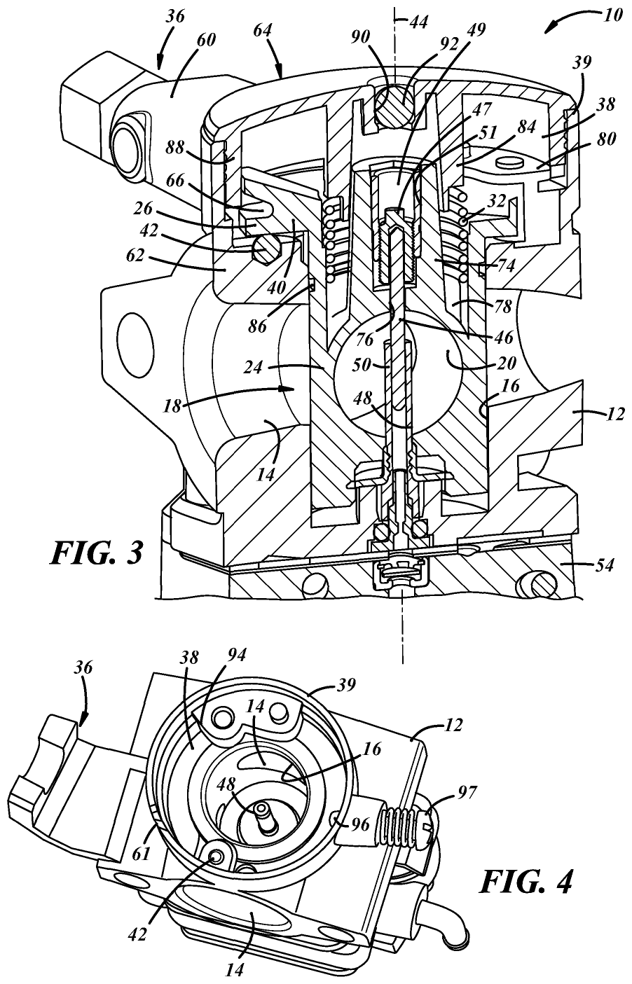

Referring in more detail to the drawings, FIGS. 1-3 illustrate a rotary throttle valve carburetor 10 that includes a carburetor main body 12 provided with a fuel and air mixing passage 14. Air enters the mixing passage 14 at one end, is mixed with fuel, and a fuel and air mixture flows out of an outlet end of the mixing passage 14 for delivery to an engine. The main body 12 also includes a valve bore 16 (FIGS. 3 and 4) extending perpendicular to and communicated with the mixing passage 14. A rotary throttle valve 18 is rotatably and axially movably received in the valve bore 16 and includes an intake or valve passage 20 therethrough that is variably aligned or registered with the mixing passage 14 as the throttle valve 18 is rotated to selectively open and close the mixing passage 14. The main body 12 preferably is formed of cast metal, such as diecast aluminum, or by other suitable methods and materials known in the art.

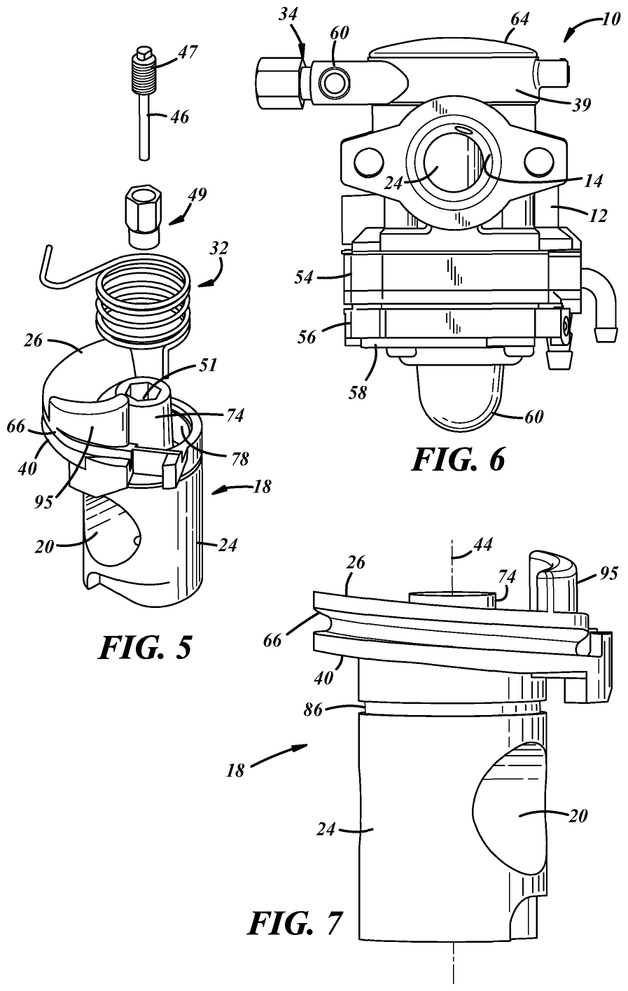

Rotation of the throttle valve 18 causes both the valve passage 20 to align or mis-align longitudinally with the mixing passage 14, and the throttle valve 18 to rise or fall axially within the valve bore 16 under control of a cam interface as will be described below. The throttle valve 18 includes a valve body 24 and a throttle lever 26 coupled to the valve body. The throttle lever 26 is coupled to driver (shown as a wire 28 of a remote control cable 30 in FIGS. 1 and 2) that is actuated to rotate the throttle valve 18 toward a wide open throttle position wherein the valve passage 20 is nearly or completely aligned with the mixing passage 14. A return spring 32 (FIGS. 3 and 5) may yieldably bias the throttle valve 18 for rotation back toward its idle position, wherein the valve passage 20 is less or not at all aligned with the mixing passage 14, as desired for a given application. The wire 28 passes through an end of an outer tube or sheath 34 of the control cable 30 which is secured to a mount fitting 36, and from there extends into a chamber 38 of the main body 12 that is spaced from the mixing passage 14 and defined at least in part by a sidewall 39.

As the cable 30 is actuated, the throttle valve 18 is rotated toward its wide open position and a cam surface 40 (FIGS. 3, 5 and 7) defined on the throttle lever 26 rides over a cam follower 42 (FIGS. 3 and 4), which may include a ball carried by the main body 12. The slope of the cam surface 40 causes the throttle valve 18 to move axially upward (relative to the axis of rotation 44 of the throttle valve 18) during rotation. In at least some implementations, the cam follower 42 may be carried directly by the main body 12 of the carburetor and not on an intervening plate or body associated with the throttle lever as in some prior art carburetors. Such intervening plates on prior art carburetors are formed of plastic and the position of the ball may change (e.g. the ball may be forced into the plastic) under the forces experienced in use. With the cam follower 42 received directly in the main body, which is formed from metal, the position of the ball will not change in use providing a more consistent cam interface, and throttle valve movement.

As shown in FIGS. 3 and 5, to vary the fuel flow in and from the carburetor, the throttle valve 18 may carry a needle 46. The needle 46 may be carried by the throttle lever 26 or valve body 24 at one end or between its ends, project downward into the valve passage 20, and have a distal or free end that is received in a main fuel nozzle 48. To retain the position of the needle 46, a fitting 47 may be carried by the needle. The fitting 47 may be threaded into a sleeve 49 that is fitted into a counterbore 51 in the throttle valve 18. The sleeve may be press-fit or threaded into the counterbore 51, or carried by the throttle valve 18 in some other way. The sleeve 49 may be formed from plastic, and the threads on the fitting 47 may be self-tapping or the sleeve may include complementary threads as desired. In this way, a spring may not be needed, in at least some implementations, to help maintain a desired position of the needle 46.

The main fuel nozzle 48 may be carried by the main body 12 and may have a fuel outlet 50 that is, in at least some positions of the throttle valve 18, at least partially blocked by the needle 46. As the throttle valve 18 rotates and moves vertically within the valve bore 16, the needle 46 moves with the throttle valve 18 and slides axially within the main fuel nozzle 48 thereby adjusting or changing the size or flow area of the fuel outlet 50. In addition, rotation of the throttle valve 18 adjusts the degree or extent of communication between the mixing passage 14 and the valve passage 20 directly effecting the amount of air flow through the passage 14. Generally, the higher the vertical position of the throttle valve 18, the greater the airflow through the mixing passage 14, the larger the fuel outlet flow area, and the greater the fuel flow into the valve bore 16 and out of the mixing passage 14.

In conventional manner, the carburetor 10 may include a fuel pump assembly arranged or defined at least in part between a first plate 54 and the main body 12, and a fuel metering assembly arranged or defined at least in part between a second plate 56 and the first plate 54. The fuel metering assembly and fuel pump assembly may each include separate diaphragms and valves to control fuel flow within and among these assemblies, as is known in the art. A retainer 58 coupled to the second plate 56 secures a peripheral edge of a flexible and resilient priming bulb 60 to the carburetor 10. When the priming bulb 60 is repetitively depressed manually and released, prior to starting of the engine, fuel vapor and air existing in the fuel pump assembly and the fuel metering assembly is evacuated and replaced with liquid fuel.

As can be seen by comparison of FIG. 5 showing the throttle valve 18 with FIG. 11 which shows a prior art throttle valve 200, the throttle valve 18 is simpler and has fewer components compared to the prior art throttle valve 200. The prior art throttle valve 200 starts out as a plurality of individual and separate pieces that are assembled into a unit, such as a body 202, a multi-part throttle lever 204 (including an overmolded support needed for rigidity and strength) and a shaft 206 interconnecting the body and lever. As shown in FIG. 5, the throttle lever 26 is formed from the same piece of material and is integrally formed with the valve body 24, rather than being a separate component that is attached by a mechanical fastener to the throttle body. In this way, the throttle valve 18 is easier to handle and assemble, and the orientation and alignment (e.g. concentricity) of the throttle lever 26 relative to the throttle body 24 can be improved across a production run of carburetors for more accurate opening and closing of the throttle valve 18, as well as more accurate positioning of the cam surface 40 relative to the cam follower 42 and main fuel nozzle 48. Further, there is no worry of fasteners or other connectors/connections becoming loose over time so the reliability of the throttle valve 18 is improved.

Still further, the wire 28 may be coupled directly to the throttle lever 26 rather than to a separate connector such as a swivel 208 which was needed on the prior art throttle lever 204. The direct connection of the wire 28 to the throttle lever 26 permits the force to be applied from the wire to the throttle lever more in line and not axially offset from the throttle lever 26, which can reduce the force needed to rotate the throttle lever 18. This can be seen, for example, in FIGS. 3 and 6 wherein the wire 28 enters a passage 60 of the main body 12 leading to the chamber 38 at generally the same axial height as the throttle lever to which the wire is attached. This permits the force of the wire 28 to be more aligned with the throttle lever 26 so that the force is more directly applied and a lower force may be used to rotate the throttle valve 18. FIGS. 1, 2 and 4 show a different implementation wherein the fitting 36 is not enclosed (e.g. there is no enclosed passage) and the wire 28 passes through an opening 61 in the chamber wall 39.

Further, the throttle lever 26 may be located close to the valve bore 16 in which the throttle valve 18 is received, and axially adjacent to the mixing passage 14 (e.g. axially adjacent to a wall 62 of the main body 12 defining the mixing passage, rather than adjacent to an intervening plate that is received on the main body as in some prior art carburetors) so that a relatively low bending moment is created by the force applied to the throttle lever 26 and less lateral support is needed for the throttle valve 18.

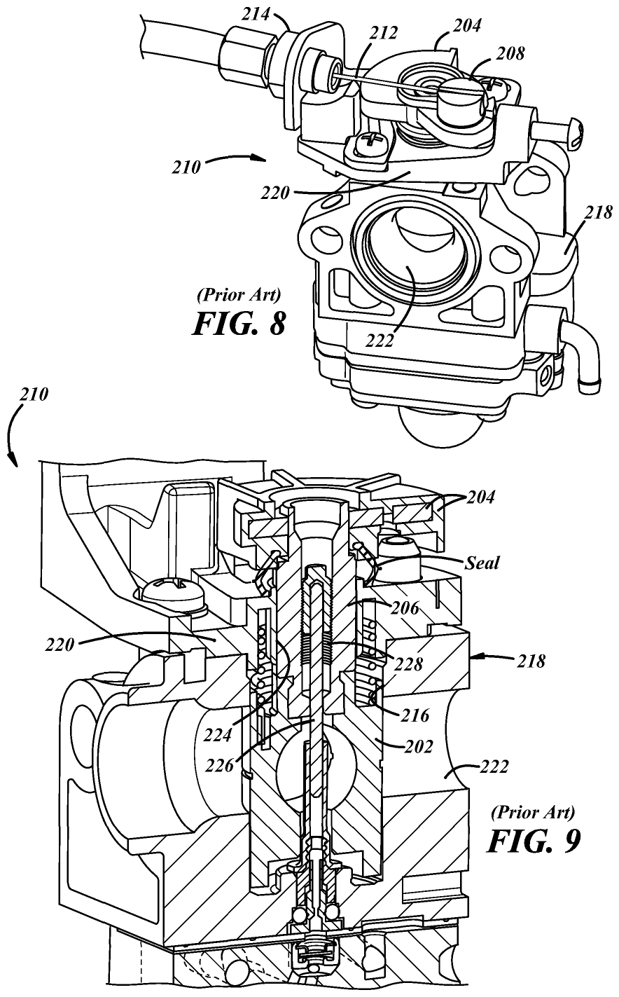

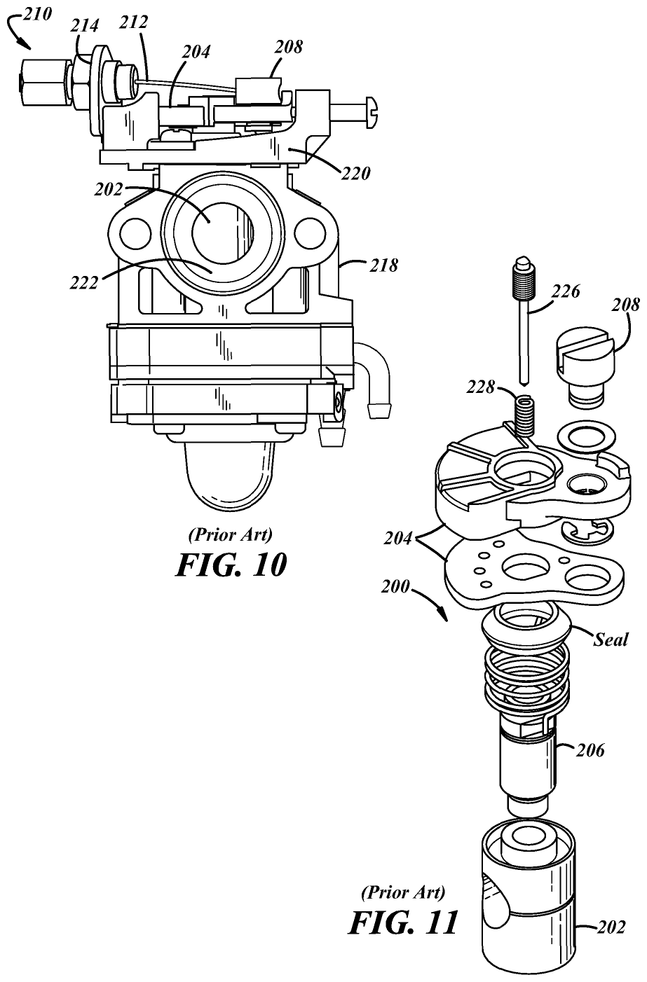

In the prior art carburetor 210, as shown in FIGS. 8-10, a throttle wire 212 passes through a fitting 214 that is axially offset from the lever 204 and couples to the swivel 208 at a location axially offset from the throttle lever 204. Hence, the force provided by the wire 212 in the prior art carburetor 210 is axially offset from the valve bore 216 (FIG. 9) by a significant distance which creates a greater bending moment on the throttle valve 200 and can increase the force needed to rotate the throttle valve 200. To counter the bending moment on the throttle valve 200, increased lateral support of the throttle valve 200 is needed within the body 218 of the carburetor 210 which increases the weight and cost of the carburetor 210. Further, the prior art carburetor 210 includes an intervening throttle lever plate 220 that is received on the body 218, and includes the fitting 214 and other components associated with the throttle lever 204 (e.g. rotation stops to limit rotation of the throttle valve 200). To extend through this intervening plate 220, the shaft 206 is relatively long and is made of metal for rigidity and strength. This spaces the throttle lever from the mixing passage 222 and increases a bending moment on the throttle valve 200 because the wire force is applied at a location axially spaced from the valve bore 216 and mixing passage 222. Further, as noted above, the cam follower is carried by the intervening plate 220 and not by the carburetor body 218. The shaft 206, body 202, valve bore 216 and an opening 224 (FIG. 9) in the intervening plate 220 through which the shaft 206 extends, must all be concentric for smooth rotation of the throttle valve 200 and this concentricity among multiple parts is difficult to accurately maintain in a production run of these multiple components. Also, the metal shaft includes internal threads to receive a needle valve 226. Vibrations in use may change the position of the needle so a spring 228 is provided to help maintain the position of the needle valve 226 and this requires extra components, which increases the cost and the difficulty in manufacturing and assembling the carburetor.

Further, in the carburetor 10 shown in FIGS. 1-7, the direct wire connection to the integral throttle lever 26 permits the throttle lever to be enclosed within the chamber 38, such as by a cover 64. The cover 64 may prevent contaminants from entering the chamber 38, and may also provide a tamper resistant interface to inhibit unintended adjustment of the needle 46 or throttle valve 18 generally. Therefore, the cam follower 42 and cam surface 40 (e.g. the cam interface) may be enclosed, and not exposed to the environment. This may reduce wear of the cam surface 40 and cam follower 42 that may otherwise be caused by dust or dirt on one or both components. Some prior art carburetors include the cam follower in the bottom of the valve bore, adjacent to the main fuel nozzle, and provide the cam surface on the bottom of the valve body which provides some protection against contamination at the cam interface. But that arrangement increases the distance between the metering assembly and the fuel nozzle which can affect engine performance in certain conditions.

Here, in the carburetor 10, the cam interface can be provided between the main body 12 and the throttle lever 26, to enable a decreased distance between the metering assembly and the fuel nozzle outlet 50, while also permitting the cam interface to be sealed or enclosed. In the example shown in the drawings, the cam follower 42 is directly carried by the main body 12, and is shown as being carried directly in the wall 62 that defines the mixing passage 14 (e.g. in a pocket on the opposite side of the wall 62 from the mixing passage). Hence, the cam follower 42 is set in metal and its position remains consistent throughout the useful life of the carburetor. To retain and maintain the proper orientation of the wire 28 relative to the throttle lever 26 and within the chamber 38, the throttle lever 26 may include a peripheral groove 66 in which the wire 28 is wound and unwound as the throttle lever rotates. In this way, the wire 28 is trapped between the chamber wall 39 and the throttle lever 26 to maintain a desired alignment and attachment of the wire with the throttle lever. To retain the wire 28, the throttle lever 26 may include a coupler, which in the example shown includes a pocket 68 in which a ferrule or end fitting 70 on the wire 28 is received, and a stop surface 72 which abuts and retains the ferrule or wire end fitting 70 as best shown in FIG. 2.

The throttle body 18 may also include an integrally formed shaft 74 extending axially and coaxially arranged with the fuel nozzle 48. The shaft 74 may include the counterbore 51 or another area for connection of the needle 46 to the throttle valve 18, and may also serve to retain the return spring 32 in place relative to the throttle valve. With the shaft 74 integrally formed with the throttle body 24, the concentricity of the shaft 74 and an opening 76 (FIG. 3) through which the needle 46 extends can be improved relative to the valve bore 16 and fuel nozzle 48. As shown, the shaft 74 may be defined in part by a peripheral channel 78 in which the return spring 32 is received, with one end the return spring bearing on the throttle valve 18 and its other end trapped beneath a retaining plate 80 fixed to the main body 12 (such as by a screw 82). As shown in FIG. 2, the retaining plate 80 may overlie the channel 78 to retain the spring 32 in the channel, but the plate 80 is spaced from the throttle valve 18 so that the throttle valve may axially move as commanded by engagement of the cam surface 40 and cam follower 42 as the throttle valve 18 is rotated. In addition to rotatably biasing the throttle valve 18, the return spring 32 may also axially bias the throttle valve down onto the cam follower 42, and the retaining plate 80 or some other component may axially compress the spring 32 to provide an axially directed force on the throttle valve 18. Instead of the plate 80, as shown in FIG. 3, the shaft 74 may be partially received within a boss 84 on the cover 64 when the cover is installed on the main body 12, and the boss 84 may axially compress the spring 32 to provide a desired axially directed biasing force on the throttle valve 18.

A seal 86 (FIGS. 3 and 7) may be provided between the body 24 and the main body 12 (e.g. at the wall 62) within the valve bore 16 to inhibit or prevent air flow between the chamber 38, the portion of the valve bore 16 adjacent to the chamber, and the mixing passage 14. The seal 86 may be defined by an o-ring or the like. Or the seal 86 may simply be defined by an open groove formed about the periphery of the throttle body at a location between the mixing passage and the chamber, as shown in FIGS. 3, 5 and 7. While not wishing to be bound to any theory, the groove 86 is believed to create a turbulent boundary to air flow therethrough as air bounces or reflects around within the groove, and this reduces the air flow rate from one side of the groove to the other. The absence of an o-ring or other seal that relies upon compression or engagement with the main body 12 and throttle valve 18 facilitates rotation of the throttle valve (less friction/interference to rotation) and reduces the number of parts in and the cost of the carburetor 10.

To attach the cover 64 to the main body 12, a peripheral rim 88 or edge of the cover 64 may be received within or over the chamber wall 39, and/or the boss 84 may be attached (e.g. snap-fit or friction fit) onto the shaft 74. To permit adjustment of the needle 46 (which may include threads so that rotation of the needle axially moves it relative to the fuel outlet 50), the cover 64 may include an opening 90 aligned with the needle 46 in assembly. After adjustment, which may occur when the carburetor 10 is assembled onto an engine, the opening 90 may be blocked by a plug 92 to prevent or inhibit further needle adjustment, if desired.

A stop surface 94 within the chamber 38, which may be integral with the main body 12 or separately provided and coupled to the main body, limits rotation of the throttle valve 18 in one direction, such as by engagement with a stop 95 on the throttle valve 18, and defines the wide open position of the throttle valve 18. The stop 95 may be integrally formed on the throttle valve, from the same piece of material as the body 24 and lever 26. The idle position of the throttle valve 18 may be defined by an adjustable idle stop, such as by an end 96 of an adjustment screw 97 threaded into a bore formed in the main body 12 and extending into the chamber 38. Hence, rotation of the adjustment screw 97 axially advances or retracts the end 96 relative to the chamber 38 to adjust the point of engagement with the throttle lever which point of engagement defines the idle position of the throttle valve 18.

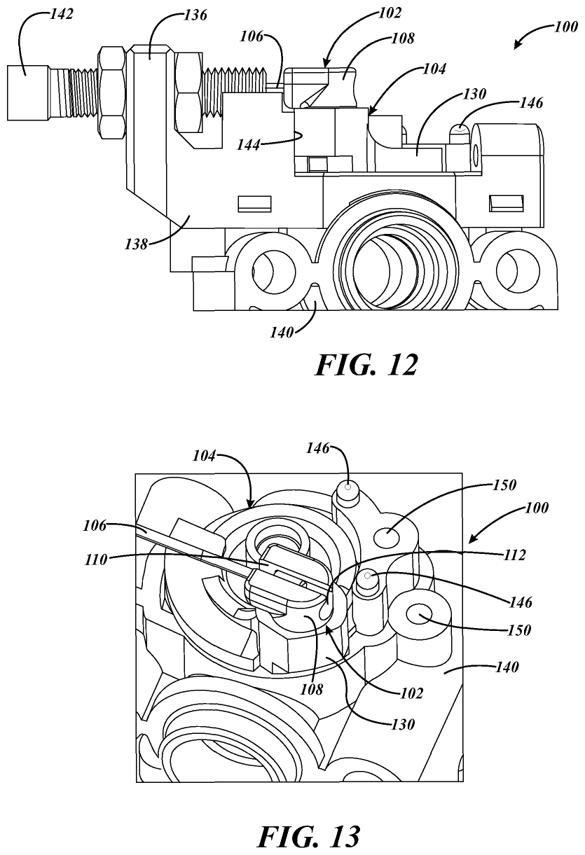

In other forms, a carburetor 100 may include a swivel 102 or other wire connector that is coupled to the throttle valve 104 as shown in FIGS. 12-16. In some implementations, as noted above, it may be desirable to connect the wire directly to the throttle valve without any swivel or connector separate from the throttle valve. In other implementations, a swivel 102 may be used. One reason a swivel 102 may be used is to limit the bending or wrapping of the wire 106 about the throttle valve 104, for example, in applications where the wire 106 is less flexible and wrapping the wire around the throttle valve 104 is difficult or not practical. In such applications, the wire 106 may be maintained generally straight and not wrapped around the throttle valve 104 by use of a swivel 102 or other connector that rotates relative to the throttle valve to maintain a generally linear orientation of the wire as the swivel and throttle valve are rotated through the range of motion of the throttle valve.

The swivel 102 may include a head 108 in which a groove 110 and/or a pocket 112 are formed to receive and retain the wire 106 and a fitting 114 on the wire. A shank 116 extends axially from the head 108 and includes a reduced diameter intermediate portion 118 and an enlarged knob 120 axially spaced from the intermediate portion. The knob 120 may include a first portion 122 at a generally constant radial distance from an axis 124 of the swivel and a second portion 126 that is at a reduced radial distance from the axis 124 of the swivel than is the first portion so that the knob does not have a circular periphery. In the implementation shown, the non-circular, second portion 126 is a flat section formed in the periphery of the knob 120.

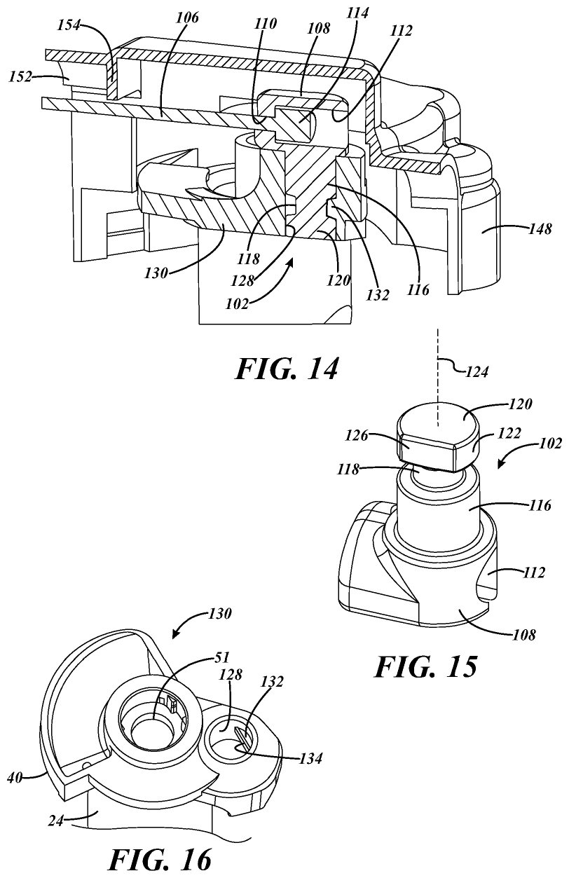

The swivel 102 may be carried by the throttle valve 104 in any suitable manner. In at least some implementations, the swivel 102 is received in a bore 128 in the radially outwardly extending throttle valve lever 130 and may rotate relative to the throttle valve 104. In the implementations shown in FIGS. 14 and 16, the throttle valve 104 includes a flange 132 extending inwardly into the bore 128. The flange 132 may have an inner surface 134 that is complementary to or otherwise designed to allow the knob 120 to pass by when the second portion 126 of the knob is aligned with the inner surface 134. Where the second portion 126 is flat, as shown, the inner surface 134 may also be flat. Hence, the shank 116 of the swivel 102 may be received in the bore 128 and advanced until the knob 120 passes the flange 132. Then the swivel 102 can be rotated about its axis 124 to overlap the first portion 122 of the knob 120 with the flange 132 and thereby axially trap the swivel 102 within the bore 128. The first and second portions 122, 126 of the knob 120 can be arranged so that the second portion is not aligned with the flange inner surface 134 during normal rotation of the throttle valve 104 between its idle and wide open positions. In this way, the swivel 102 can be reliably retained on the throttle valve 104 without need of any clips, pins or other connectors to facilitate assembly and disassembly of the throttle valve (e.g. for service or replacement of either the swivel or throttle valve). The shank 116 may be sized for a relatively close fit within the bore 128 of the throttle valve 104 to limit tilting of the swivel 102 relative to the bore which can increase the forces at an edge or fulcrum point between the swivel 102 and throttle valve lever 130. Likewise, the knob 120 may be sized for a close fit in the bore 128 to also inhibit tilting of the swivel 102 relative to the throttle valve 104 while still permitting the swivel to relatively freely rotate relative to the throttle valve.

As shown in FIG. 12, the wire 106 extends through a mount 136 defined on a bracket 138 of the carburetor body that is carried by a main body 140 of the carburetor 100. The mount 136 could otherwise be formed in or as part of the main body 140, as shown in the carburetor 10. The bracket 138 may surround the throttle valve 104 and have a bore aligned with the valve bore 16 to receive the throttle valve 104 therethrough, as shown in FIGS. 12 and 13. A conduit 142 (FIG. 12) of the Bowden wire 106 may be fixed to the mount 136 in a known manner and the wire may extend through the conduit 142 and be coupled to the swivel 102, such as by a ferrule or other end fitting 114 being received in the groove 110 and/or pocket 112 in the head 108 of the swivel 102 as shown in FIGS. 12-14. The bracket 138 may provide a stop surface 144 that is engaged by the throttle valve lever 130 in the wide open throttle position of the throttle valve 104 while the swivel 102 normally does not engage the bracket 138 as shown in FIG. 12. The bracket 138, or as shown, the carburetor main body 140 may further include one or more projections 146 adapted to be received in cavities in a cover 148, and/or one or more cavities 150 adapted to receive projections on the cover 148 to snap-fit retain the cover on the bracket 138. One or more of the cavities 150 or projections 146 may also or instead be used to mount a retaining plate (not shown) on the bracket 138, which may be constructed and arranged like the retaining plate 80 noted in the carburetor 10, to retain the throttle valve 104 within the valve bore 16. In this implementation, the cover 148 may overlap and enclose the bracket 138 and throttle valve 104, and may be coupled to the bracket 138 and/or the main body 140 of the carburetor 100, as desired. The bracket 138 may include an opening 152 through which the wire 106 extends, and one or more seals (which may be defined by or include one or more walls 154) may be provided between the cover and the wire (or conduit) to inhibit contaminants from entering the cover. The remainder of the throttle valve 104 and the carburetor 100 may be constructed and arranged as set forth above with regard to the throttle valve 18 and carburetor 10.

As the throttle valve 104 is rotated between its idle and wide open positions, the swivel 102 travels with the throttle valve lever 130 and also rotates relative to the throttle valve lever and maintains the wire 106 in a generally straight orientation (at least compared to the prior embodiment wherein the wire wraps around and unwraps from the throttle valve when the throttle valve is rotated). This permits a less flexible wire 106 to be used while also providing a throttle valve 104 that is otherwise formed in one piece (i.e. the throttle valve lever 130 is integrally formed from same piece of material as remainder of throttle valve 104). Accordingly, the benefits achieved by the throttle valve lever 130 and throttle valve body being formed from the same piece of material (e.g. concentricity, durability, reduction in parts, integrally formed cam surface, etc) are also achieved in this implementation with the exception of the connection of the wire 106 to the throttle valve 104 which is done via a separate component, namely, the swivel 102.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

1. A rotary throttle valve for a carburetor, comprising:
a body adapted to be received in a valve bore of a carburetor for rotation within and relative to the valve bore, and the body includes a valve passage through which air flows; and
a throttle lever integrally formed with the body and adapted to be coupled to a driver that rotates the throttle valve.

2. The valve of claim 1 wherein the body rotates about an axis and the valve also includes an axially sloped cam surface defined at least in part on the throttle lever and adapted to engage a cam follower to axially displace the body and throttle lever as the throttle valve rotates.

3. The valve of claim 1 which also includes a shaft integrally formed with the body and the throttle lever and including an opening extending to the valve passage, and a needle carried by the body and extending through the opening.

4. The valve of claim 1 wherein the body includes a seal.

5. The valve of claim 4 wherein the seal is defined by a groove formed in the body.

6. The valve of claim 1 which also includes a swivel rotatably carried by the throttle valve lever.

7. The valve of claim 6 wherein the swivel includes a knob and the throttle valve lever includes a bore in which the knob is received and a flange extending into the bore, the knob overlies a portion of the flange to retain the swivel in the bore.

8. The valve of claim 1 wherein the throttle valve lever includes a peripheral groove in which a wire used to rotate to rotate the throttle valve is taken up and paid out as the throttle valve rotates.

9. The valve of claim 8 wherein the throttle valve includes a pocket adapted to couple the wire to the throttle valve.

10. A carburetor, comprising:
a main body with a mixing passage and a valve bore intersecting the mixing passage; and
a rotary throttle valve having:
a valve body adapted to be received in the valve bore of the main body for rotation within and relative to the valve bore, and the valve body includes a valve passage aligned with the mixing passage and variably registered with the mixing passage as the throttle valve rotates in the valve bore; and
a throttle lever integrally formed with the valve body and adapted to be coupled to a driver that rotates the throttle valve.

11. The carburetor of claim 10 wherein the body rotates about an axis and the valve also includes an axially sloped cam surface defined at least in part on the throttle lever and the main body carries a cam follower engaged by the cam surface to axially displace the throttle valve as the throttle valve rotates.

12. The carburetor of claim 11 wherein the cam surface and cam follower are received within a chamber defined at least in part by the main body and which is enclosed to inhibit contaminants from fouling the cam surface or cam follower.

13. The carburetor of claim 11 which also includes a cover that defines part of the chamber.

14. The carburetor of claim 10 wherein the throttle lever is received immediately adjacent to a wall of the main body that defines part of the mixing passage.

15. The valve of claim 10 which also includes a swivel rotatably carried by the throttle valve lever.

16. The valve of claim 15 wherein the swivel includes a knob and the throttle valve lever includes a bore in which the knob is received and a flange extending into the bore, the knob overlies a portion of the flange to retain the swivel in the bore.

17. The valve of claim 10 wherein the throttle valve lever includes a peripheral surface about which a wire used to rotate to rotate the throttle valve is taken up and paid out as the throttle valve rotates.
